(19) United States
(12) Patent Application Publication
(10) Pub. No.: US 2016/0353065 A1
(43) Pub. Date: Dec. 1, 2016

(54) Diagnostic Camera for Tubular Conveyor Systems

(71) Applicant: Intraco, Inc., Oskaloosa, IA (US)

(72) Inventor: Eric L. Nicholson, Oskaloosa, IA (US)

(21) Appl. No.: 14/725,089

(22) Filed: May 29, 2015

(51) Int. Cl. H04N 7/18; H04N 1/00; H04N 5/225

(52) U.S. Cl. CPC H04N 7/183; H04N 5/2253; H04N 1/00209; H04N 2201/0084

(57) ABSTRACT

A diagnostic device for viewing problems occurring inside of a circuitous tube in a flexible member conveyor system or the like by attaching a camera to the flexible member or to one of the discs attached to the flexible member so that the camera can take photos or video to show views of the tube as the camera passes through the circuitous tube flexible member conveyor system, the flexible member typically being a cable or a chain.

### TECHNICAL FIELD

This invention relates generally to a diagnostic device for viewing problems occurring inside of a circuitous tube in a flexible member conveyor system or the like, such as a cable or chain conveyor system.

### BACKGROUND

Cable or chain conveyor systems of a type including a circuitous tube and a cable or chain with a plurality of discs attached thereto can be used for conveying granular or powdery materials for feeding animals or poultry, whole plant particles for food such as corn, beans or coffee, friable materials such as powders, chunks, flakes, pellets, parts, shavings, crumbles, granules, fluff, regrind and dust; or industrial products such as ball bearings or threaded fasteners. U.S. Pat. Nos. 3,905,473, 4,071,136, 4,395,973, 7,267,218 and 8,863,940 (all incorporated herein by reference in their entirety) illustrate cable conveying systems of the general type referred to above. See www.cablevey.com.

Occasionally there will be something in the tube conveyor system that causes the cable/chain conveyor system to not work in an optimum fashion. A trouble shooting list has been developed to find problems and fix them. But if the problem lies within the tube itself, such as a burr on the inside of the metal tube for example, it is very difficult to find such a problem and quickly fix it.

Accordingly, there is a need for a diagnostic device to help diagnose problems in a cable conveyor system that are inside the circuitous tube or along the path of the discs when they travel outside the tube, such as through a drive unit which drives the cable and discs through the circuitous tube.

### SUMMARY OF THE INVENTION

The present invention relates to a diagnostic device for viewing problems occurring inside of a circuitous tube in a cable/chain conveyor system or the like. The present invention solves the aforementioned diagnostic problem by attaching a camera to the cable/chain, cable connector or one of the discs attached to the cable so that the camera can take photos or video to show views of the inside of the tube as the camera passes through the circuitous tube cable conveyor system.

### BRIEF DESCRIPTION OF THE DRAWINGS

The above needs are at least partially met through provision of the apparatus described in the following detailed description, particularly when studied in conjunction with the drawings, wherein:

FIG. 1 is an enlarged view of a cable attached together at its ends to form a circuitous loop and also showing one disc with a camera attached thereto for traveling with the disc through the tube while the conveyor system is in operation and simultaneously capturing images on a storage media or transmitting the images wirelessly using radio frequency waves;

FIG. 2 is a top view of the disc with a camera attached thereto of FIG. 1;

FIG. 3 is an exploded view taken along line 3-3 of FIG. 2, showing the structure which holds the camera in place;

FIG. 4 is an exploded view taken along line 4-4 of FIG. 3;

FIG. 5 is a view of the disc with the camera attached thereto in readiness to pass through a drive sprocket for driving/pulling the cable with the discs thereon through the circuitous tube;

FIG. 6 is a perspective view of the fully assembled disc with the camera attached thereto.

FIG. 7 is a view of a person's hand in dashed lines holding a camera of the type shown in FIGS. 1-6;

FIG. 8 is a view of a person's hands in dashed lines removing a memory card from the camera; and

FIG. 9 is a perspective view of a part of a laptop computer showing how the memory card taken from the camera in FIG. 8 can be inserted into the computer to view the images and or/video taken by the camera after it has passed through the circuit of the tubular conveyor.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

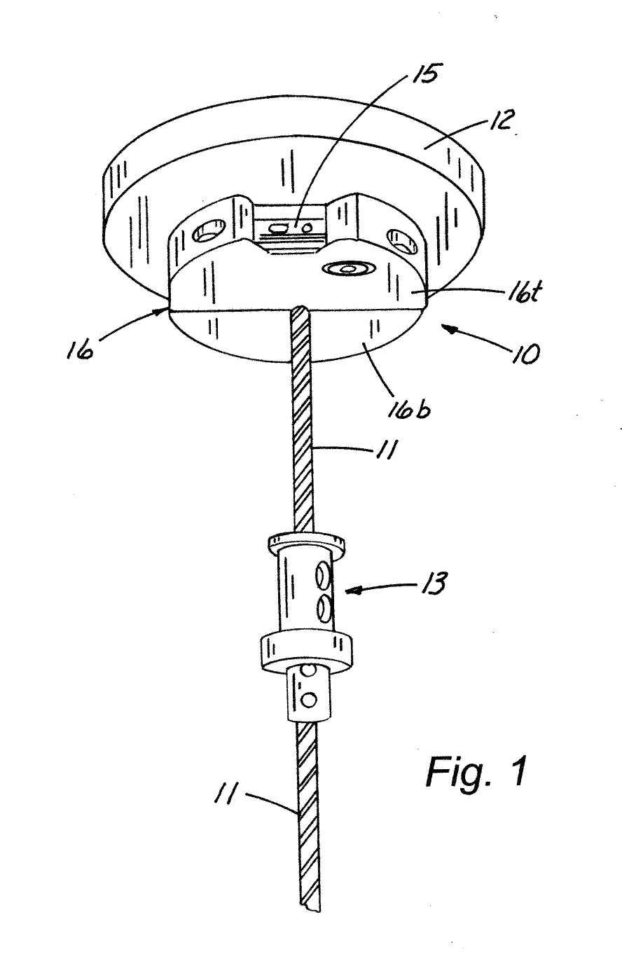

Referring now to the drawings, wherein like reference numerals indicate identical or similar parts throughout the several views, FIGS. 1-6 show a tube camera constructed in accordance with the present invention.

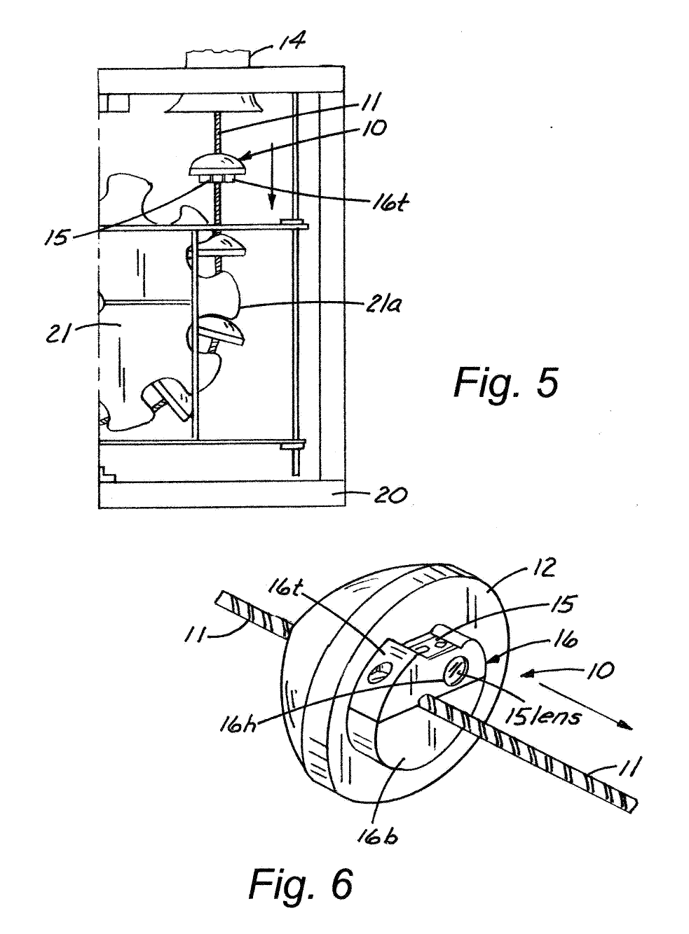

A preferred embodiment of the present invention is shown in FIGS. 1-9. FIG. 1 shows a preferred embodiment of the present invention 10 attached to a flexible member 11 in the form of a cable. A cable connector 13 is shown in FIG. 1 for attaching the ends of the cable 11 together to form a circuit within a tubular structure 14 shown partially in FIG. 5 of the type shown in the prior art patents specified above. A camera 15 is held to the cable 11 by a two piece clamp 16, including a top part 16t held together with bottom part 16b by threaded fasteners 17 that extend through holes 17h in clamp part 16t and thread into threaded openings 17t in clamp part 16b. The cable 11 extends through an opening formed by half circle 16to on clamp part 16t and half circle 16bo on clamp part 16b. A lens 15 lens on camera 15 can be seen through the hole 16h in top clamp 16t in FIG. 6.

U.S. Pat. No. 7,267,218 to Van Zee et al. shows a cable connector like cable connector 13 for attaching the ends of a cable together in a cable conveyor system, so the details of that connector 13 are not shown herein.

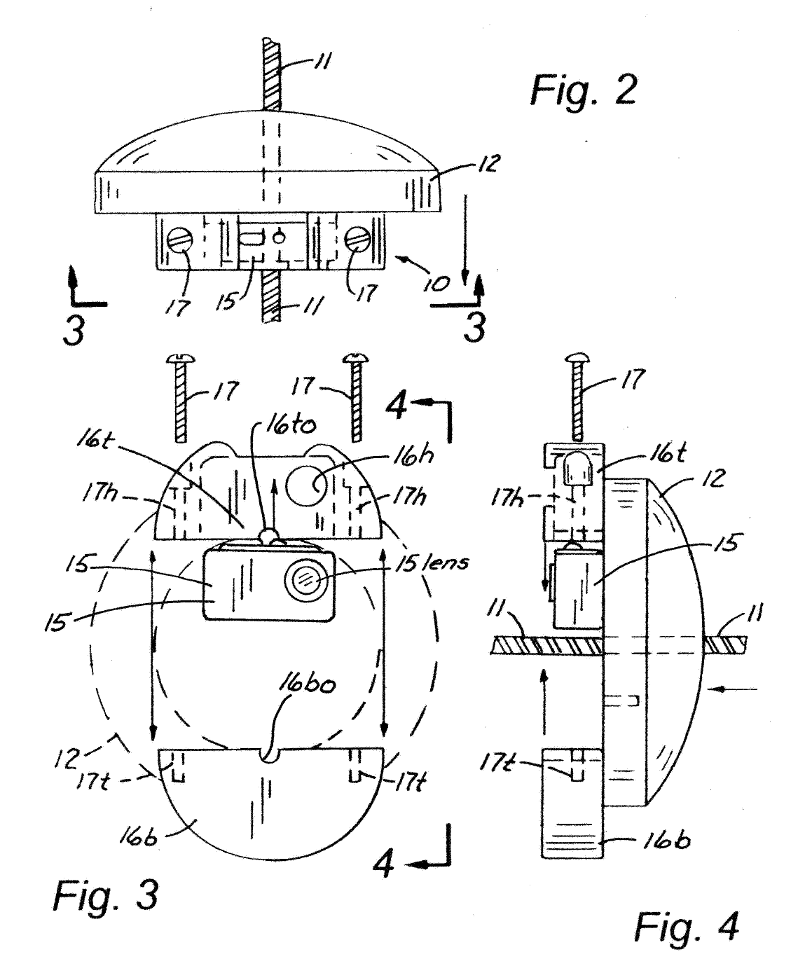

FIGS. 1 and 2 of U.S. Pat. No. 8,863,940 to Sterner et al. show the equivalence of discs on cables and discs on chains in a tube conveyor. Therefore the definition of a “flexible member” as used in this document shall include, but not be limited to, a cable or a chain of the general type show in the '940 Sterner et al patent.

“Disc” as used in this document is used in a generic sense and is not limited to structure which is circular, but instead is intended to be any structure which is attached to such flexible member that is capable of pushing a material to be conveyed through a tube.

“Tube” (or tubular) also is not intended to be limited to a circular cross sectional shape, but instead can be made of a cross sectional shape generally matching the shape of the disc so that material being conveyed in the tube will be pushed along without such material passing around the disc.

Looking to FIG. 5, the camera 15 and top clamp part 16t, attached to disc 10 and cable 11 as it goes through a drive housing 20 which has projections 21a that pull the cable 11 and discs 10 through the tubular circuit 14 as shown in more detail in U.S. patent application Ser. No. 14/290,229, filed May 29, 2014, now U.S. Pat. No. ______, which is incorporated herein by reference in its entirety.

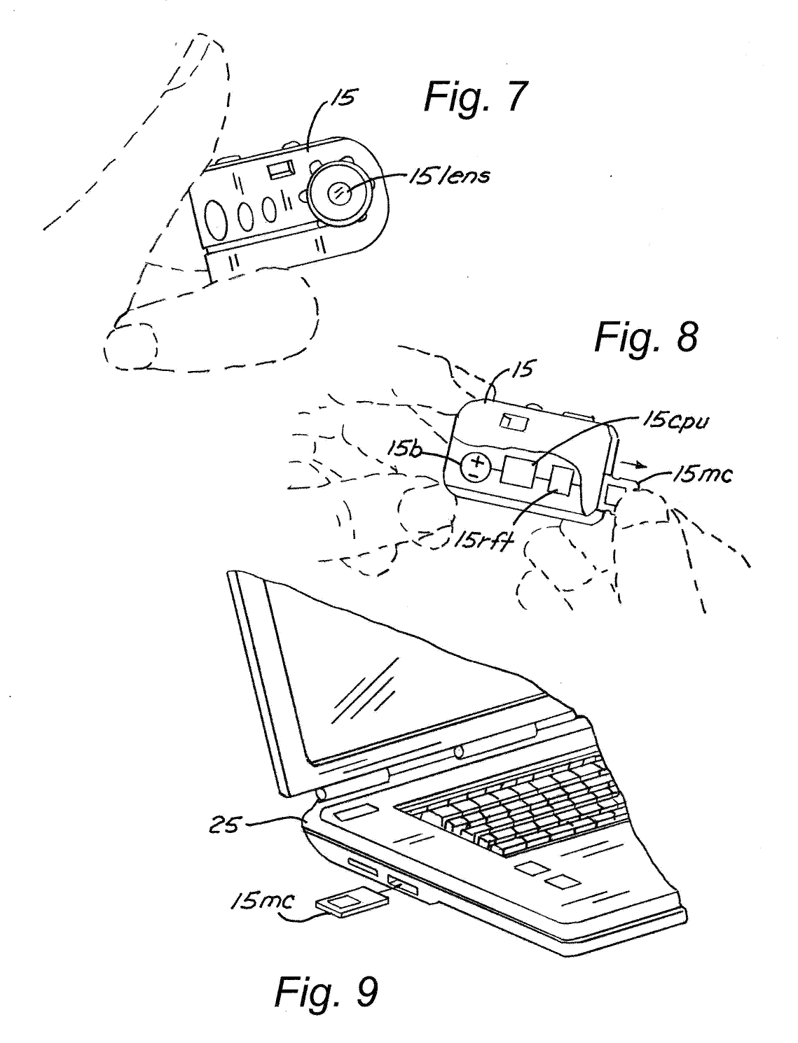

The camera 15 shown in FIGS. 1-5 is shown in more detail in FIGS. 7 and 8. FIG. 7 shows the camera 15 being held in the hand of a person in dashed lines. FIG. 8 shows that the camera 15 has a battery 15b, connected to a CPU 15cpu, which is attached to an optional radio frequency transmitter 15rft. The camera 15 has a removeable memory card 15mc.

In operation, the camera 15 can be clamped to the cable 11 and disc 12 with the memory card 15mc in the camera 15. Then, preferably with the cable conveyor tube being empty of materials normally conveyed, the system is operated by using the drive unit 20 to cause the cable 11, discs 12 and camera 15 clamped to the cable 11 and disc 12 as shown in FIGS. 1, 5 and 6 with the camera taking images, which is preferably a video, but which can be other images. The preferred operation is depicted in FIGS. 7-9 after the system is stopped and the camera 15 removed as shown in FIG. 7. After that, as shown in FIG. 8, the memory card 15mc is removed and placed into a computer 25 as shown in FIG. 9. Then the video or other images taken by the camera 15 can be viewed on the computer 25. Alternatively, the images of the camera 15 can be transmitted live on the computer 25 by using an optional radio frequency transmitter 15rft shown in FIG. 8.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. A diagnostic apparatus comprising:
a flexible member having a plurality of discs attached thereto, the flexible conveyor member and plurality of discs being adapted to be moved through a tube for conveying materials disposed in the tube; and
a camera attached to at least one of the flexible member or one of the discs.

2. The diagnostic apparatus of claim 1 wherein the camera comprises a battery and a removable memory card.

3. The diagnostic apparatus of claim 1 wherein the camera comprises a battery and a radio frequency transmitter for transmitting images wirelessly to a computer for viewing the images.

4. The diagnostic apparatus of claim 1 wherein the camera comprises a battery, internal memory and a connector to facilitate connection of a data transfer communication cable.

5. The diagnostic apparatus of claim 1 further comprising a clamp operatively holding the camera attached to the flexible member.

6. The diagnostic apparatus of claim 5 further wherein the clamp includes at least two pieces.

7. The diagnostic apparatus of claim 1 further comprising a clamp operatively holding the camera attached to one of the discs.

8. The diagnostic apparatus of claim 1 wherein the flexible member is a cable having a first end and a second end and with a cable connector connecting the first end to the second end thereof and wherein the camera is connected to the flexible member via the cable connector.
